(19) United States
(12) Patent Application Publication
(10) Pub. No.: US 2021/0174404 A1
(43) Pub. Date: Jun. 10, 2021

(54) SYSTEM AND METHOD FOR CREATING CUSTOMERS PROFILE BASED ON CUSTOMERS DIGITAL NAVIGATION

(71) Applicant: Abhishek Pitti, India (IN)

(72) Inventor: Abhishek Pitti, India (IN)

(21) Appl. No.: 16/749,507

(22) Filed: Jan. 22, 2020

(30) Foreign Application Priority Data
Dec. 10, 2019 (IN) 201911041341

(51) Int. Cl. G06Q 30/02; G06Q 30/00; H04W 64/00; H04W 84/18; H04W 4/029

(52) U.S. Cl. CPC G06Q 30/0281; G06Q 30/016; H04W 4/029; H04W 64/006; H04W 84/18; H04W 64/003

(57) ABSTRACT

A system to create a profile of a customer includes a telecom server hosted behind a firewall of a telecom operator to host a tracking pixel to capture digital behavior data of the customer, a customer recognition module connected to the telecom server to identify the customer through the tracking pixel; a native server connected to the telecom server over a network and provides a native service platform to facilitate the merchant to create an account; and a merchant server to host the digital touchpoints of the merchant and having consent modules to allow the customer to initiate a consent commands; the native server includes a processor; and a memory communicatively coupled to the processor and having a profiling module to match attributes captured by the tracking pixel with the device identifiers to identify the customer on the digital touchpoints to create a customer profile.

### BACKGROUND

### 1. Field of the Invention

The present invention relates to identification, and creation of a customer's profile, in particular to a system and a method for creating a customer's profile based on customer's digital navigation on digital touchpoints of a merchant.

### 2. Description of Related Art

With the advent of digitalization of businesses, digital marketing has become an integral part of any business process. Digital marketing benefits businesses of all sizes by providing access to the mass potential customers at an affordable price. Digital marketing allows personalized and targeted marketing. The main advantage of digital marketing is that targeted customers can be reached in a cost-effective and measurable way. While the business or merchants can reach global customers with digital marketing, it is a challenge to stand out against competitors and to grab attention among the many marketing messages aimed at customers online.

Additionally, there are a number of legal considerations around collecting and using customer's data for digital marketing purposes. Further, when the merchants do digital promotions, they never get access to customer's profiles who visited their digital promotions. In the absence of details of the customer's profile, the merchants are unable to predict the value of publishing inventory, and the effectiveness of the campaign. Therefore, there is a need for a secure system and method to provide a deterministic profile of the customer so that the merchants can easily determine the effectiveness of their promotions.

### SUMMARY OF THE INVENTION

The present invention mainly solves the technical problems existing in the prior art. In response to these problems, the present invention provides a system and a method for creating a customer's profile based on the customer's digital navigation on digital touchpoints of a merchant.

An aspect of the present disclosure relates to a method for creating a profile of a customer when the customer casually navigates one or more digital touchpoints associated with a merchant. The method includes a step of capturing digital behavior data of the customer through a tracking pixel hosted on a telecom operator. The telecom operator includes a firewall. A telecom server is hosted behind the firewall of the telecom operator. The tracking pixel is header enriched by the telecom operator by integrating one or more device identifiers associated with a computing device of the customer, and personal data pertaining to the customer to identify the computing device and the customer. The method includes a step of facilitating the merchant to create an account through a native service platform provided by a native server connected to the telecom server over a network. The merchant obtains an identification code module on creating the account over the native service platform. The identification code module is integrated into the digital touchpoints associated with the merchant on providing an approval command to a plurality of predefined terms and conditions. The merchant initiates an acknowledgment command indicative of the creation of a digital copy of the terms and conditions on the digital touchpoints to integrate the identification code module on the digital points. The integration of the identification code module indicates the identification of the customer when the digital touchpoints of the merchant are accessed by the customer. The method includes a step of allowing the customer to initiate a consent command to the indication presented by the identification code module on the digital touchpoints of the merchant through a plurality of consent modules. The consent command from the customer is stored in a merchant server, the native server, and the telecom server. The method includes a step of identifying the customer through the tracking pixel connected to the customer recognition module when the customer loads the digital touchpoints of the merchant on a browser of the computing device associated with the customer. The method includes a step of matching a plurality of attributes captured by the tracking pixel with the device identifiers to identify the customer on the digital touchpoints to create a customer profile through a profiling module. The method includes a step of sharing the customer's profile with the merchant server based on a digital journey of the customer on the digital touchpoints of the merchant through a sharing module.

In an aspect, the telecom server examines the consent command initiated by the customer and transmits the device identifiers to the native server.

In an aspect, the digital touchpoints include but not limited to one or more advertisement banners of the merchant, one or more web pages of the merchant, one or more social media platforms of the merchant, one or more software applications of the merchant and one or more multimedia platforms or websites of the merchant.

Another aspect of the present invention relates to a system to create a profile of a customer when the customer casually navigates one or more digital touchpoints associated with a merchant. The system includes a telecom server, a customer recognition module, a native server, and a merchant server. The telecom server is hosted behind a firewall of a telecom operator to host a tracking pixel to capture the digital behavior data of the customer. The tracking pixel is header enriched by the telecom operator by integrating one or more device identifiers associated with a computing device of the customer, and personal data pertaining to the customer to identify the computing device and the customer. The customer recognition module is connected to the telecom server to identify the customer through the tracking pixel when the customer loads the digital touchpoints of the merchant on a browser of the computing device associated with the customer.

The native server is connected to the telecom server over a network and provides a native service platform to facilitate the merchant to create an account. The merchant obtains an identification code module on creating the account over the native service platform. The identification code module is integrated into the digital touchpoints associated with the merchant on providing an approval command to a plurality of predefined terms and conditions. The merchant initiates an acknowledgment command indicative of the creation of a digital copy of the terms and conditions on the digital touchpoints to integrate (burnt) the identification code module on the digital points. The merchant server hosts the digital touchpoints of the merchant. The integration of the identification code module indicates the identification of the customer when the digital touchpoints of the merchant are accessed by the customer.

The telecom server, native server, and merchant server include a plurality of consent modules. The consent module placed at the merchant server allows the customer to initiate a consent command to the indication presented by the identification code module on the digital touchpoints of the merchant. In an aspect, the consent command from the customer is stored in the merchant server, the native server, and the telecom server.

The native server includes a processor and a memory. The memory is communicatively coupled to the processor, wherein the memory stores instructions executed by the processor. The memory includes a profiling module, the consent module associated with the native server and a sharing module. The profiling module matches a plurality of attributes captured by the tracking pixel with the device identifiers to identify the customer on the digital touchpoints to create a customer profile. The sharing module shares the customer's profile with the merchant server based on a digital journey of the customer on the digital touchpoints of the merchant.

Accordingly, one advantage of the present invention is that it can provide the deterministic customer's profile so that the merchants can easily evaluate the Return on investment (RoI) of their promotions.

Accordingly, one advantage of the present invention is that it enables the merchant to push customized offers to the customers based on the customer's interactions with the digital touchpoints of the merchant.

Accordingly, one advantage of the present invention is that it facilitates the merchants to restructure their promotions and marketing strategy based on the customer's profile.

Accordingly, one advantage of the present invention is that it automatically and dynamically creates profiles of the customers which includes digital journey (such as a number of sites visited, time spent on each website, which section or products visited most, etc.) and shopping behavior (purchase history, potential future purchases) of the customer.

Other features of embodiments of the present invention will be apparent from accompanying drawings and from the detailed description that follows.

Yet other objects and advantages of the present invention will become readily apparent to those skilled in the art following the detailed description, wherein the preferred embodiments of the invention are shown and described, simply by way of illustration of the best mode contemplated herein for carrying out the invention. As we realized, the invention is capable of other and different embodiments, and its several details are capable of modifications in various obvious respects, all without departing from the invention.

Accordingly, the drawings and description thereof are to be regarded as illustrative in nature, and not as restrictive.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 illustrates a network implementation of the present system to create a profile of a customer when the customer casually navigates one or more digital touchpoints associated with a merchant, in accordance with an embodiment of the present subject matter.

FIG. 2 illustrates a block diagram of the various modules within a memory of the native server, in accordance with at least one embodiment.

FIG. 3 illustrates a flowchart of the method for creating a profile of a customer when the customer casually navigates one or more digital touchpoints associated with a merchant, in accordance with an embodiment of the present subject matter.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques, and procedures either known to, or readily developed from known manners, means, techniques and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

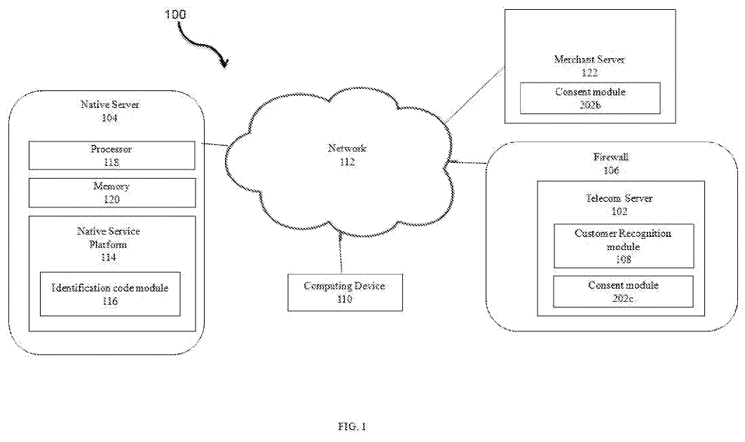

Referring now to the drawings, FIG. 1 illustrates a network implementation of the present system 100 to create a profile of a customer when the customer casually navigates or browses or visits one or more digital touchpoints associated with a merchant, in accordance with an embodiment of the present subject matter. Examples of the digital touchpoints include but are not limited to one or more advertisement banners of the merchant, one or more web pages of the merchant, one or more social media platforms of the merchant, one or more software applications of the merchant and one or more multimedia platforms of the merchant. The system 100 includes a telecom server 102, a customer recognition module 108, a native server 104, and a merchant server 122.

The telecom server 102 is hosted behind a firewall 106 of a telecom operator to host a tracking pixel to capture the digital behavior data of the customer. The tracking pixel is header enriched by the telecom operator 102 by integrating one or more device identifiers associated with a computing device 110 of the customer, and personal data pertaining to the customer to identify the computing device 110 of the customer. In an embodiment, the tracking pixel is a pixel URL. Typically, in the header enrichment process data fields are added in an HTTP header used by the telecom server 102. The data fields may include but not limited to IMEI, IMSI, MSISDN UID or other data (may be personal data such as name, age, location, etc.) to identify the customer (subscriber) or computing devices.

The tracking pixel is an HTML code snippet which is loaded when the customer visits the website or opens an email related to the merchant. The tracking pixel is useful for tracking customer's digital behavior and conversions such as several the websites visited, actions performed, time stamps, etc. With the tracking pixel, the merchants can acquire digital data for online marketing, web analysis, email marketing retargeting, etc. Examples of the device identifiers include but are not limited to a service set identifier (SSID) number, media access control address (MAC address), International Mobile Equipment Identity (IMEI), IMSI, Mobile Station International Subscriber Directory Number (MSISDN), etc. Examples of the computing device 110 include but not limited to a laptop, a desktop, a smartphone, a smart device, a smartwatch, a phablet, and a tablet. In an embodiment, the telecom server 102 stores a plurality of identification numbers such as phone number or Mobile Station International Subscriber Directory Number (MSISDN) corresponding to computing devices 110 associated with the customers. The customer recognition module is connected to the telecom server 102 to identify the customer through the tracking pixel when the customer loads the digital touchpoints of the merchant on a browser of the computing device 110 associated with the customer.

The native server 104 is connected to the telecom server 102 over a network 112 and provides a native service platform 114 to facilitate the merchant to create an account. The network 112 may be a wired or a wireless network, and the examples may include but are not limited to the Internet, Wireless Local Area Network (WLAN), Wi-Fi, Long Term Evolution (LTE), Worldwide Interoperability for Microwave Access (WiMAX), General Packet Radio Service (GPRS), Bluetooth (BT) communication protocols, Transmission Control Protocol and Internet Protocol (TCP/IP), User Datagram Protocol (UDP), Hypertext Transfer Protocol (HTTP), cloud network, File Transfer Protocol (FTP), ZigBee, EDGE, infrared (IR), Z-Wave, Thread, 5G, USB, serial, RS232, NFC, RFID, WAN, and/or IEEE 802.11, 802.16, 2G, 3G, 4G cellular communication protocols.

The merchant obtains an identification code module 116 (pixel code) on creating the account over the native service platform 114. The identification code module 116 is integrated (burnt) to the digital touchpoints associated with the merchant on providing an approval command to a plurality of predefined terms and conditions. The merchant initiates an acknowledgment command indicative of the creation of a digital copy of the terms and conditions on the digital touchpoints to integrate (burnt) the identification code module 116 on the digital points.

The merchant server 122 hosts the digital touchpoints of the merchant. The integration of the identification code module 116 indicates the identification of the customer when the digital touchpoints of the merchant are accessed by the customer. The telecom server 102, native server 104 and merchant server 122 include a plurality of consent modules 202a, 202b, and 202c. The consent module 202b placed at the merchant server allows the customer to initiate a consent command to the indication presented by the identification code module on the digital touchpoints of the merchant. In an embodiment, the consent command from the customer is stored in consent modules 202a, 202b, and 202c of the native server 104, merchant server 122 and the telecom server 102 respectively.

The native server 104 includes a processor 118 and a memory 120. The memory 120 is communicatively coupled to the processor 118, wherein the memory 120 stores instructions executed by the processor 118. Processor 118 may include at least one data processor for executing program components for executing user- or system-generated requests. Processor 118 may include specialized processing units such as integrated system (bus) controllers, memory management control units, floating-point units, graphics processing units, digital signal processing units, etc.

Processor 118 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 118 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 118 may be disposed of in communication with one or more input/output (I/O) devices via an I/O interface. I/O interface may employ communication protocols/methods such as, without limitation, audio, analog, digital, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

The memory 120 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The processor 118 may be implemented as one or more microprocessors, microcomputers, microcontrollers, digital signal processors, central processing units, state machines, logic circuitries, and/or any devices that manipulate signals based on operational instructions. Among other capabilities, at least one processor 118 is configured to fetch and execute computer-readable instructions stored in the memory 120.

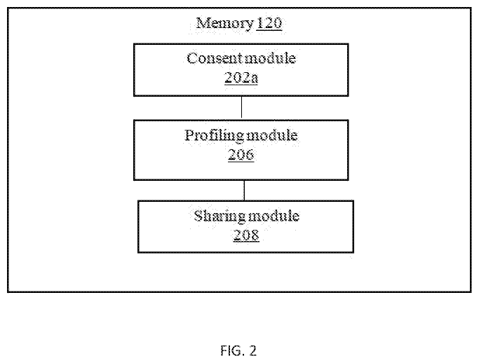

FIG. 2 illustrates a block diagram of the various modules within the memory 120 of the native server 104, in accordance with at least one embodiment. FIG. 2 is explained in conjunction with FIG. 1. The memory 120 includes a consent module 202a, a profiling module 206, and a sharing module 208. The consent modules 202a, 202b, and 202c, customer recognition module 108, profiling module 206, and sharing module 208 include routines, programs, objects, components, data structures, etc., which perform particular tasks or implement particular abstract data types. The consent command from the customer is stored in memory 120 of the native server 104. In an embodiment, the telecom server 102 examines the consent command initiated by the customer and transmits the device identifiers to the native server 104.

The profiling module 206 matches a plurality of attributes captured by the tracking pixel with the device identifiers to identify the customer on the digital touchpoints to create a customer profile. The profiling module 206 may utilize one or more machine learning (ML) algorithms to create the customer's profile and may direct the native server 104 to transmit the customers' profile to the merchant server 122 so that the merchant can easily identify the return on investment (RoI) of their promotions and also increases the conversion rate. The sharing module 208 shares the customer's profile with the merchant server 122 based on a digital journey of the customer on the digital touchpoints of the merchant.

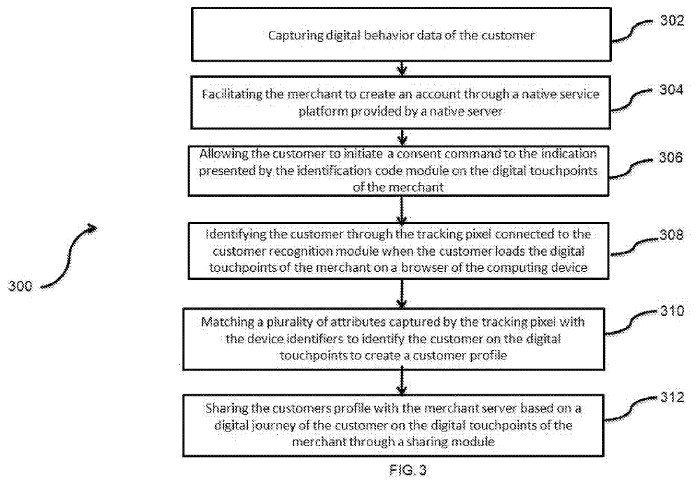

FIG. 3 illustrates a flowchart 300 of the method for creating a profile of a customer when the customer casually navigates one or more digital touchpoints associated with a merchant, in accordance with an embodiment of the present subject matter. In an embodiment, the digital touchpoints include but are not limited to one or more advertisement banners of the merchant, one or more web pages of the merchant, one or more social media platforms of the merchant, one or more software applications of the merchant and one or more multimedia platforms of the merchant. The method includes a step 302 of capturing digital behavior data of the customer through a tracking pixel hosted on a telecom operator. The telecom operator includes a firewall and the telecom server is hosted behind the firewall. The tracking pixel is header enriched by the telecom operator by integrating one or more device identifiers associated with a computing device of the customer, and personal data pertaining to the customer to identify the computing device and the customer. The method includes a step 304 of facilitating the merchant to create an account through a native service platform provided by a native server connected to the telecom server over a network. The merchant obtains an identification code module (pixel code) on creating the account over the native service platform. The identification code module is integrated into the digital touchpoints associated with the merchant on providing an approval command to a plurality of predefined terms and conditions. The merchant initiates an acknowledgment command indicative of the creation of a digital copy of the terms and conditions on the digital touchpoints to integrate (burnt) the identification code module on the digital points. The integration of the identification code module indicates the identification of the customer when the digital touchpoints of the merchant are accessed by the customer.

The method includes a step 306 of allowing the customer to initiate a consent command to the indication presented by the identification code module on the digital touchpoints of the merchant through a consent module. The consent command from the customer is stored in a merchant server, the native server, and the telecom server. In an embodiment, the telecom server examines the consent command initiated by the customer and transmits the device identifiers to the native server.

The method includes a step 308 of identifying the customer through the tracking pixel connected to the customer recognition module when the customer loads the digital touchpoints of the merchant on a browser of the computing device associated with the customer. The method includes a step 310 of matching a plurality of attributes captured by the tracking pixel with the device identifiers to identify the customer on the digital touchpoints to create a customer profile through a profiling module. The method includes a step 312 of sharing the customer's profile with the merchant server based on a digital journey of the customer on the digital touchpoints of the merchant through a sharing module.

In operation, the pixel URL is hosted on the telecom server and the pixel URL is header enriched by the telecom operator. Header enrichment means when the pixel URL is loaded on the browser of the customer's phone then the telecom server passes the phone number of the customer in the header of the pixel URL. The pixel URL is burnt or integrated within the digital touchpoints (e.g. ad banner, website) of the merchant (e.g. retailer or brand). The merchant creates an online account with the native server. The native server provides the native service platform (e.g. digital platform, e-commerce website) to the merchant where they login and creates their online account. The native service platform provides the identification code module (pixel code) and to use that pixel code as a merchant they need to give permission to certain terms and conditions (T&C) and merchants will acknowledge that they are copying the given T&C text on their digital touchpoints so that they can inform their customers (users or ad users) that this pixel code is burnt and that they can be identified using this pixel code. The merchants can also agree that whenever their website is loaded, the way cookie consent is asked, the customer would agree for their identification. The merchants can make required changes in the language so that they can communicate the customers that along with the cookies, this kind of customer identification module (pixel code) is burnt on the website and that the customer will be identified. The actual language can be modified or structured based on the legal requirements of the jurisdictions. Once the merchant agrees to this, they will copy the code from the native server platform and paste the pixel code on their website so that this pixel code is considered burnt on their website.

Further, the way customer accepts cookies on their website, similarly, the customer will accept pixel code on the merchant's web pages. This consent from the customer will be stored digitally with the merchants. This consent can be produced as and when required by an administrator of the native server or any other entity whether legal or any other business entity in the value chain. When the merchant's website or web pages are loaded on the customer's phone browser, the Pixel URL will also be loaded with the merchant's web page. When this pixel URL is loaded on customer's phone browser, telecom server performs header enrichment on the pixel URL. Telecom server which is hosted behind the telecom operator's firewall receives the customer's phone number. In the telecom server, the customer's consent is checked. If the customer has consented, then the native server gets the phone number of the customer.

In an embodiment, the customer consent gathering process is a part of a consent network. The native server maps the different attributes from various data sources with that phone number to identify the customers based on the digital touchpoints and creates a complete profile of the customer. The native server shares the customer's profile with the merchants based on their journey on various digital touchpoints of the merchant such as website, application or ad banner. Thus, the present system and method identify the customers through telecom header enrichment when a customer browses the merchant's digital touchpoints. The present system and method also provide the deterministic customer's profile so the merchants can easily gauge the RoI of their promotions.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system to create a profile of a customer when the customer casually navigates one or more digital touchpoints associated with a merchant, the system comprising:
a telecom server hosted behind a firewall of a telecom operator to host a tracking pixel to capture digital behavior data of the customer, wherein the tracking pixel is header enriched by the telecom operator by integrating one or more device identifiers associated with a computing device of the customer, and personal data pertaining to the customer to identify the computing device and the customer;
a customer recognition module connected to the telecom server to identify the customer through the tracking pixel when the customer loads the digital touchpoints of the merchant on a browser of the computing device associated with the customer;
a native server connected to the telecom server over a network and provides a native service platform to facilitate the merchant to create an account, wherein the merchant obtains an identification code module on creating the account over the native service platform, wherein the identification code module is integrated to the digital touchpoints associated to the merchant on providing an approval command to a plurality of predefined terms and conditions, wherein the merchant initiates an acknowledgment command indicative to creation of a digital copy of the terms and conditions on the digital touchpoints to integrate the identification code module on the digital points; and
a merchant server to host the digital touchpoints of the merchant, wherein the integration of the identification code module indicates the identification of the customer when the digital touchpoints of the merchant are accessed by the customer, wherein the telecom server, the native server and the merchant server comprising:
a plurality of consent modules to allow the customer to initiate a consent command to the indication presented by the identification code module on the digital touchpoints of the merchant, wherein the consent command from the customer is stored in the merchant server, the native server and the telecom server,
wherein the native server comprises:
a processor; and
a memory communicatively coupled to the processor, wherein the memory stores instructions executed by the processor, wherein the memory comprising:
a profiling module to match a plurality of attributes captured by the tracking pixel with the device identifiers to identify the customer on the digital touchpoints to create a customer profile.

2. The system according to claim 1, wherein the telecom server examines the consent command initiated by the customer and transmits the device identifiers to the native server.

3. The system according to claim 1, wherein the memory comprises a sharing
20 modules connected to the native server to share the profile of the customer with the merchant server based on a digital journey of the customer on the digital touchpoints of the merchant.

4. The system according to claim 1, wherein the digital touchpoints comprises one or more advertisement banners of the merchant, one or more web pages of the merchant, one or more social media platforms of the merchant, one or more software applications of the merchant and one or more multimedia platforms of the merchant.

5. A method for creating a profile of a customer when the customer casually navigates one or more digital touchpoints associated with a merchant, the method comprising steps of:
capturing digital behavior data of the customer through a tracking pixel hosted on a telecom operator, wherein the telecom operator comprises a firewall, wherein the tracking pixel is header enriched by a telecom operator by integrating one or more device identifiers associated with a computing device of the customer, and personal data pertaining to the customer to identify the computing device and the customer, wherein the telecom server is hosted behind the firewall;
facilitating the merchant to create an account through a native service platform provided by a native server connected to the telecom server over a network, wherein the merchant obtains an identification code module on creating the account over the native service platform, wherein the identification code module is integrated to the digital touchpoints associated to the merchant on providing an approval command to a plurality of predefined terms and conditions, wherein the merchant initiates an acknowledgment command indicative to creation of a digital copy of the terms and conditions on the digital touchpoints to integrate the identification code module on the digital points, wherein the integration of the identification code module indicates identification of the customer when the digital touchpoints of the merchant is accessed by the customer;
allowing the customer to initiate a consent command to the indication presented by the identification code module on the digital touchpoints of the merchant through a plurality of consent modules, wherein the consent command from the customer is stored in a merchant server, the native server, and the telecom server;
identifying the customer through the tracking pixel connected to the customer recognition module when the customer loads the digital touchpoints of the merchant on a browser of the computing device associated with the customer; and
matching a plurality of attributes captured by the tracking pixel with the device identifiers to identify the customer on the digital touchpoints to create a customer profile through a profiling module.

6. The method according to claim 5, wherein the telecom server examines the consent command initiated by the customer and transmits the device identifiers to the native server.

7. The method according to claim 5 comprises a step of sharing the profile of the customer with the merchant server based on a digital journey of the customer on the digital touchpoints of the merchant through a sharing module.

8. The method according to claim 5, wherein the digital touchpoints comprises one or more advertisement banners of the merchant, one or more web pages of the merchant, one or more social media platforms of the merchant, one or more software applications of the merchant and one or more multimedia platforms of the merchant.
